(19) United States
(12) Patent Application Publication
(10) Pub. No.: US 2025/0180702 A1
(43) Pub. Date: Jun. 5, 2025

(54) VELOCITY ESTIMATION USING INTELLIGENT REFLECTING SURFACES

(71) Applicant: The Hong Kong University of Science and Technology, Kowloon (HK)

(72) Inventors: Lei XIE, Kowloon (HK); Shenghui SONG, Kowloon (HK); Xianghao YU, Kai Tak (HK)

(21) Appl. No.: 18/961,709

(22) Filed: Nov. 27, 2024

Related U.S. Application Data
(60) Provisional application No. 63/604,907, filed on Dec. 1, 2023.

(51) Int. Cl. G01S 7/41; G01S 13/58; G01S 13/62

(52) U.S. Cl. CPC G01S 7/411; G01S 13/583; G01S 13/62

(57) ABSTRACT

Velocity estimation using intelligent reflecting surfaces (e.g., using a computerized tool), is enabled. For example, a system can comprise at least one processor, and at least one memory that stores executable instructions that, when executed by the at least one processor, facilitate performance of operations. The operations can comprise based on a first signal between a receiver and a target object, determining a second signal between the receiver and the target object, wherein the first signal comprises a direct signal, and wherein the second signal comprises an indirect signal conveyed via an intelligent reflecting surface, determining a Doppler frequency of the second signal, and based on the Doppler frequency, determining a velocity estimation of the target object.

### CROSS-REFERENCE TO RELATED APPLICATION

This application claims the benefit of U.S. Provisional Patent Application No. 63/604,907 filed Dec. 1, 2023, and entitled SYSTEM AND METHOD FOR VELOCITY ESTIMATION USING MULTIPLE INTELLIGENT REFLECTING SURFACES, which priority application is incorporated by reference herein in its entirety.

### BACKGROUND

Velocity information (e.g., of a vehicle) has many applications, such as in vehicle-to-vehicle communication and smart traffic management. For example, by accurately estimating the velocity of vehicles (and/or other moving objects such as pedestrians or cyclists), a connected vehicle can anticipate potential collision risks and take preventive measures in real-time. Additionally, velocity information plays a role in traffic management. By collecting and analyzing real-time velocity data from multiple vehicles, traffic authorities can gain valuable insights into traffic patterns, congestion hotspots, and overall traffic flow. To this end, integrated sensing and communications (ISAC) provides a platform for estimating velocity over cellular networks. However, a conventional mono-static sensing system cannot estimate velocity accurately, for instance, due to the limited information provided by the target-base station link. Furthermore, due to the complex environment, a direct link between the sensing node and the target can be blocked or can become blocked, hindering estimation of velocity.

The above-described background relating to velocity estimation is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of a non-limiting example system in accordance with one or more example embodiments described herein.

FIG. 2 is a block diagram of a non-limiting example computer executable modules in accordance with one or more example embodiments described herein.

FIG. 3 is a diagram of an example intelligent reflecting surface aided vehicle-to-infrastructure system in accordance with one or more example embodiments described herein.

FIG. 4 is a diagram of an example intelligent reflecting surface aided vehicle-to-vehicle system in accordance with one or more example embodiments described herein.

FIG. 5 is a diagram of an example intelligent reflecting surface aided indoor integrated sensing and communications system in accordance with one or more example embodiments described herein.

FIGS. 6a and 6b illustrate the Doppler effect over different links in accordance with one or more example embodiments described herein.

FIG. 7 shows the normalized root mean squared error as a function of target velocity with different signal-to-noise ratio in accordance with one or more example embodiments described herein.

FIG. 8 shows the root mean squared error performance of direct and indirect methods in which the target moves with different velocities in accordance with one or more example embodiments described herein.

FIG. 9 is a flow diagram for a process associated with velocity estimation using intelligent reflecting surfaces in accordance with one or more example embodiments described herein.

FIG. 10 is a flow diagram for a process associated with velocity estimation using intelligent reflecting surfaces in accordance with one or more example embodiments described herein.

FIG. 11 is a flow diagram for a process associated with velocity estimation using intelligent reflecting surfaces in accordance with one or more example embodiments described herein.

FIG. 12 is an example, non-limiting computing environment in which one or more embodiments described herein can be implemented.

FIG. 13 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, velocity estimation can be improved in various ways, and various example embodiments are described herein to this end and/or other ends.

Velocity estimation has numerous applications and uses. By analyzing the Doppler frequency shift of the observed signals, it is possible to estimate the velocity of a mobile device (e.g., user equipment) or a target object. However, conventional velocity estimation methods can only estimate the radial projection of the velocity on the line connecting the receiver, e.g., base station (BS), and the target, which causes significant estimation errors. Moreover, due to the complex environment, the direct link between the target and the receiver (e.g., BS) may be obstructed.

To this and other various ends, intelligent reflecting surfaces (IRS) can be utilized in various embodiments described herein to create an additional link between the target and the receiver, thus enabling a solution to overcome the challenges posed by the complex environment and improve the connectivity between the BS and the target. IRSs herein can comprise, for instance, passive metasurfaces with the ability to reflect incident signals without the use of a dedicated energy source. Embodiments herein utilize the IRSs to create additional links for accurate estimation of velocity of a target object. Embodiments herein further enable processes to estimate the velocity of a maneuvering target with the assistance of IRSs, for instance, in a scenario in which a direct link may be absent. Embodiments herein enable two efficient velocity estimation processes by exploiting the additional link(s) created by IRSs herein. In various embodiments, velocity can thus be precisely estimated.

According to an example embodiment, a system can comprise at least one processor, and at least one memory that stores executable instructions that, when executed by the processor, facilitate performance of operations, comprising based on a first signal between a receiver and a target object, determining a second signal between the receiver and the target object, in which the first signal comprises a direct signal, and in which the second signal comprises an indirect signal conveyed via an intelligent reflecting surface, determining a Doppler frequency of the second signal, and based on the Doppler frequency, determining a velocity estimation of the target object.

In one or more example embodiments, the second signal can be determined in response to a determination that the first signal is obstructed by an intermediary object located between the receiver and the target object.

In one or more example embodiments, the second signal can be determined not to be obstructed by an intermediary object located between the receiver and the target object.

In one or more example embodiments, the velocity estimation of the target object can be directly determined via a linear search on an amplitude of the first signal or the second signal and an angle of velocity of the first signal or the second signal through a defined matching filter.

In one or more example embodiments, the velocity estimation of the target object can be indirectly determined via a matching filter on the first signal or the second signal used to estimate the Doppler frequency of the first signal or the second signal, and a linear search on an amplitude of the first signal or the second signal and an angle of velocity of the first signal or the second signal through a defined matching filter.

In one or more example embodiments, the Doppler frequency of the second signal can be a first Doppler frequency, in which the intelligent reflecting surface is a first intelligent reflecting surface, and in which the operations further comprise determining a third signal between the receiver and the target object, in which the third signal comprises an indirect signal conveyed via a second intelligent reflecting surface, and determining a second Doppler frequency of the third signal, in which the velocity estimation is further determined based on the second Doppler frequency of the third signal.

In one or more example embodiments, the above operations can further comprise determining a quantity of intelligent reflecting surface aided signals associated with determining the velocity estimation of the target object with a threshold accuracy.

In one or more example embodiments, the target object can be determined to be in motion.

In one or more example embodiments, the above operations can further comprise determining a geometric relationship between the target object, the intelligent reflecting surface, and the receiver, in which the velocity estimation of the target object is further determined based on the geometric relationship.

In another example embodiment, a non-transitory machine-readable medium can comprise executable instructions that, when executed by a processor, facilitate performance of operations, comprising based on a first link between a base station and a target object, determining a second link between the base station and the target object, in which the first link comprises a direct link, and in which the second link comprises an indirect link conveyed via an intelligent reflecting surface, determining a Doppler frequency of the second link, and based on the Doppler frequency, determining a velocity estimation of the target object.

In one or more example embodiments, the first link can comprise an uplink signal.

In one or more example embodiments, the base station can comprise a radar receiver.

In one or more example embodiments, the intelligent reflecting surface can be selected from a group of intelligent reflecting surfaces that relay links between the base station and the target object.

In one or more example embodiments, the first link or the second link can comprise cellular signals transmitted via a cellular network. In this regard, the cellular network can comprise a fifth-generation cellular network or a sixth-generation cellular network.

In one or more example embodiments, the first link is determined to be obstructed by a stationary object.

In one or more example embodiments, the first link can be determined to be obstructed by a moving object.

In yet another example embodiment, a method can comprise based on a first communication between a receiver device and a target object device, determining, by a system comprising at least one processor, a second communication between the receiver device and the target object device, in which the first communication comprises a direct communication, and in which the second communication comprises an indirect communication conveyed via an intelligent reflecting surface, determining, by the system, a Doppler frequency of the second communication, and based on the Doppler frequency, calculating, by the system, a velocity estimation of the target object device.

In one or more example embodiments, calculating the velocity estimation of the target object device can comprise directly determining the velocity estimation based on a result of a linear search based on an angle of velocity of the first communication or the second communication through a defined matching filter.

In one or more example embodiments, the Doppler frequency of the second communication can be a first Doppler frequency, and calculating the velocity estimation of the target object device can comprise indirectly determining the velocity estimation using a matching filter on the first communication or the second communication to estimate second Doppler frequency of the first communication or the first Doppler frequency of the second communication, and using a result of a linear search based on an amplitude of the first communication or the second communication.

Velocity estimation can be performed, for instance, by analyzing the Doppler frequency shift. The Doppler effect refers to the change in frequency of an electromagnetic wave caused by the relative motion between the observer and the wave source and is widely utilized for velocity estimation. Conventional velocity estimation primarily adopts matched filters to estimate the motion parameters. Micro-Doppler frequency estimation can be utilized in for orthogonal frequency division multiplexing (OFDM) radar systems. Oversampling can be utilized to mitigate the inter-carrier interference caused by the Doppler effect to improve the performance of Doppler estimation. In general, performance of the matched filter (MF)-based method is limited by an inherent grid issue. To address this problem, a joint range-velocity estimation can be utilized based on the multiple signal classification process in OFDM radar systems, which achieves a higher resolution than the MF-based methods. However, due to the nature of the Doppler effect, the conventional mono-static ISAC BS can only measure the radial projection of the velocity, causing substantial estimation error. One solution is to obtain another perspective toward the maneuvering target so that the velocity can be accurately determined.

Intelligent reflecting surfaces (IRSs) can enhance the performance of both communication and sensing systems. A continuous model for IRS-aided satellite communication can be utilized, for instance, based on which the IRS phase shifters are optimized to simultaneously maximize the received power and minimize the delay and Doppler spread. A two-stage protocol for channel estimation can be utilized, for instance, for an IRS-aided high-mobility communication system, in which an IRS is deployed at a high-speed vehicle, for instance, to mitigate the Doppler effect. The localization problem in an IRS-aided single-input single-output (SISO) system can be considered, for instance, by accounting for the user equipment (UE) mobility and spatial wideband effects. However, the potential of IRSs for velocity estimation has not been previously understood. There are two major benefits of utilizing IRSs in velocity estimation. First, IRSs can be utilized to create additional links to estimate the velocity of a moving target. Second, multiple IRSs can facilitate the estimation of the real velocity even when the direct target-BS link is blocked.

Conventional mono-static ISAC systems can only estimate the relative velocity between the sensing receiver and the target, i.e., the projection of the velocity on the line connecting the sensing receiver and the target. Moreover, due to the complex environment, the direct link between a radar receiver (e.g., BS) and the target may be obstructed. Under such a circumstance, conventional estimation methods will fail to yield an accurate result.

Various embodiments herein consider the IRS-aided velocity estimation by utilizing the uplink signals from the target to the BS. Embodiments herein consider the situation in which the maneuvering target moves in a complex environment, in which the direct link between the target and the BS may be blocked. To tackle this issue, a system herein can first determine whether the direct link is available, and then determine how many IRS-aided links should be utilized for velocity estimation. By leveraging the different perspectives provided by the IRSs, the velocity can be recovered based on the Doppler frequencies estimated from two separate links.

Embodiments herein can utilize IRS-aided links, for instance, to obtain multiple perspectives for observing the Doppler frequency. In particular, embodiments herein enable two processes (e.g., the indirect and direct processes). For the indirect process, a system herein first estimates the intermediate parameters and then utilizes the intermediate parameters to estimate the velocity. In particular, a system herein first estimates the Doppler frequencies of different links in the first stage. In the second stage, the system herein determines the velocity vector based on the estimated Doppler frequencies and the geometric relation between the target, the IRSs, and the BS. For the direct process, a system herein estimates the velocity directly without estimating the intermediate parameters (e.g., Doppler frequency). Such direct and indirect processes are later discussed in greater detail.

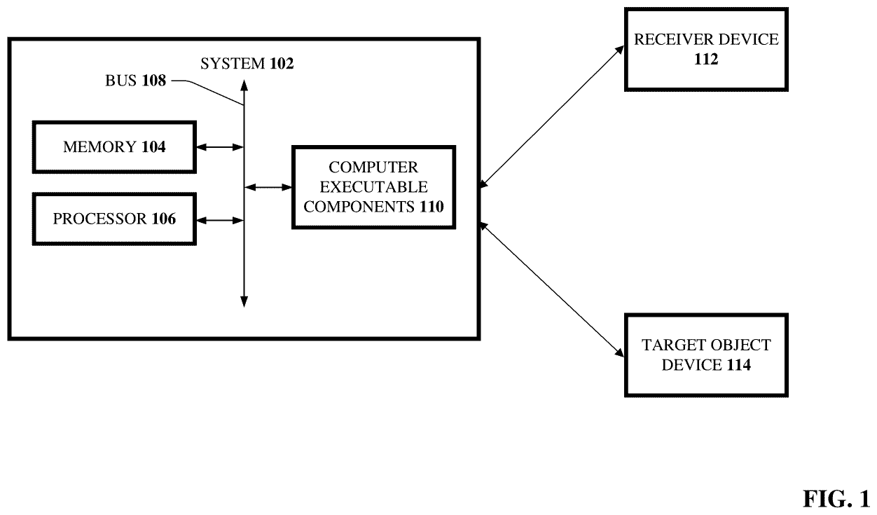

Turning now to FIG. 1, there is illustrated an example, non-limiting system 102 in accordance with one or more example embodiments herein. System 102 can comprise a computerized tool, which can be configured to perform various operations relating to velocity estimation using intelligent reflecting surfaces. The system 102 can comprise one or more of a variety of components, such as memory 104, processor 106, bus 108, and/or computer executable components 110. In various example embodiments, one or more of the memory 104, processor 106, bus 108, and/or computer executable components 110 can be communicatively or operably coupled (e.g., over a bus or wireless network) to one another to perform one or more functions of the system 102. In various example embodiments, the system 102 can further comprise and/or be communicatively coupled to a receiver device 112 and/or target object device 114.

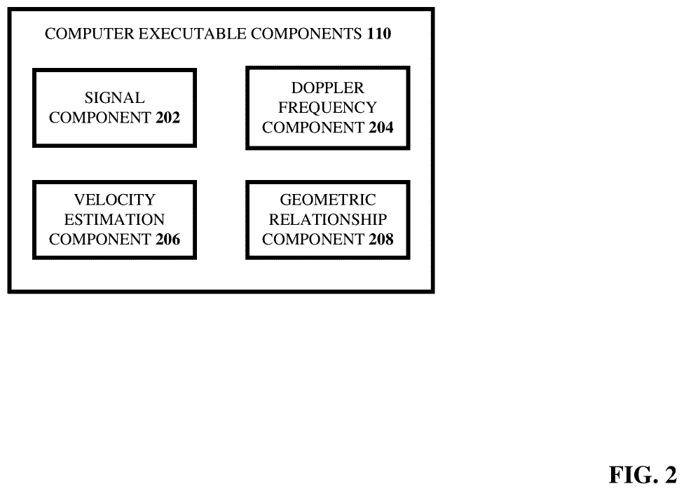

FIG. 2 illustrates a block diagram of example, non-limiting computer executable components 110 that can facilitate velocity estimation using intelligent reflecting surfaces in accordance with one or more embodiments described herein. Repetitive description of like elements employed in other embodiments described herein is omitted for sake of brevity. As shown in FIG. 2, the computer executable components 110 can comprise the signal component 202, Doppler frequency component 204, velocity estimation component 206, and/or geometric relationship component 208. It is noted that while various components described herein can perform one or more corresponding functions, processes, or actions, the computer executable components 110 as a whole and/or the processor 106 can be configured to perform one or more of the described functions, processor, or actions.

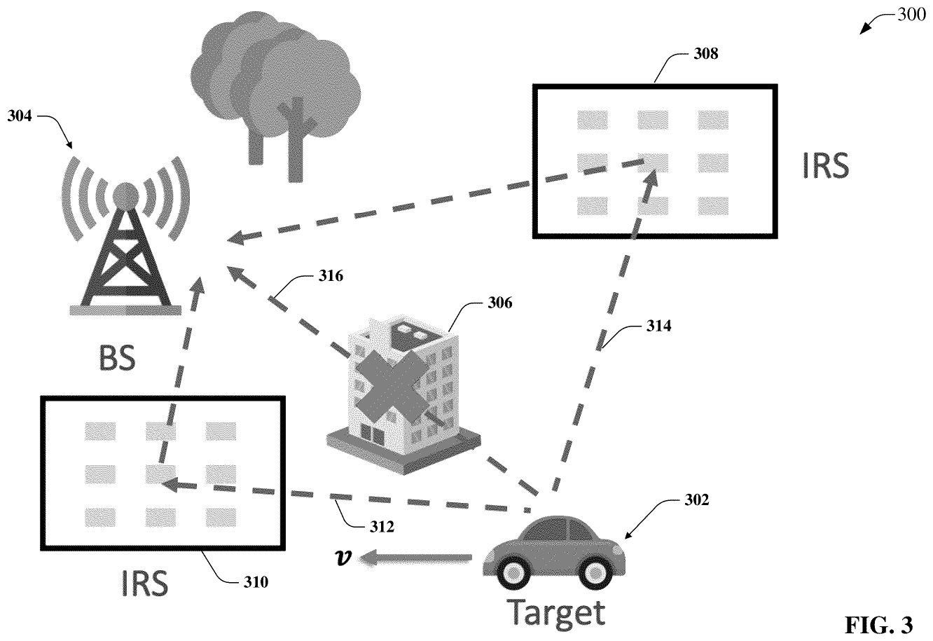

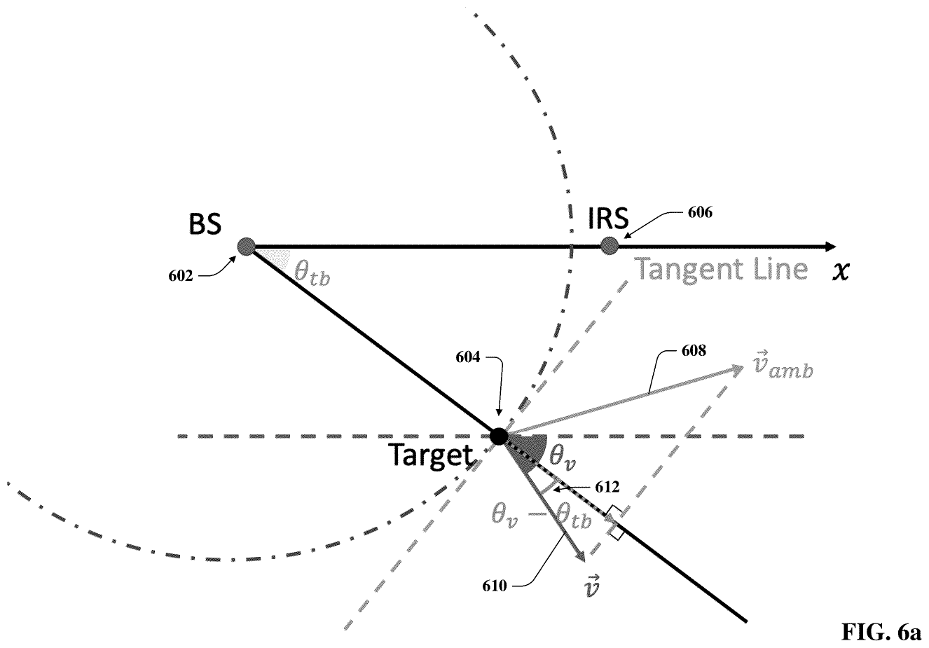

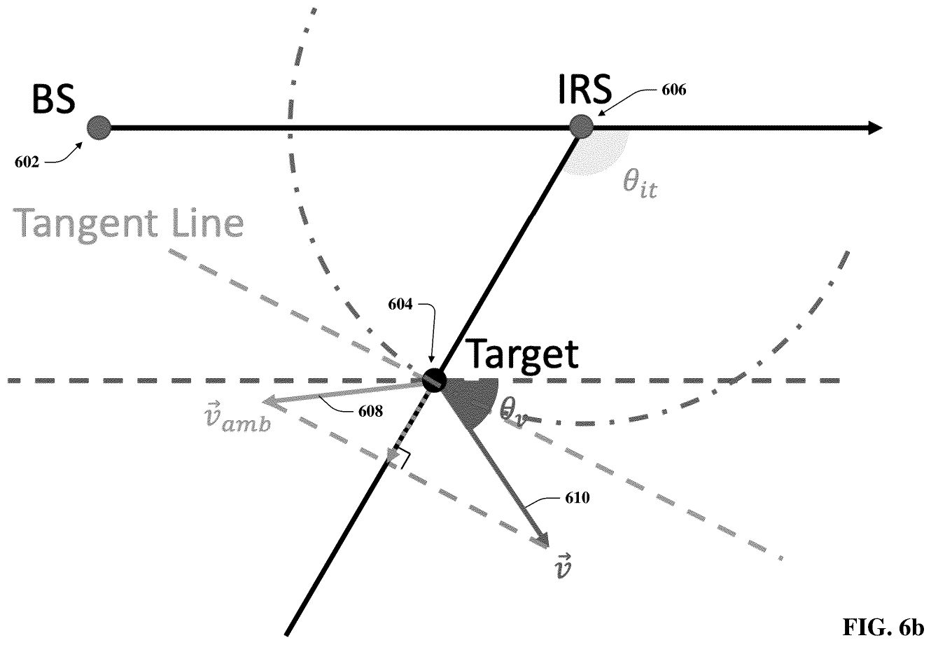

FIG. 3 is a diagram 300 of an example intelligent reflecting surface aided vehicle-to-infrastructure system (e.g., comprising the system 102) in accordance with one or more example embodiments described herein. In FIG. 3, the velocity vector of the point-like maneuvering target (e.g., target 302), denoted by v, is estimated via a base station 304 aided by two IRSs (IRS 308 and IRS 310). The base station 304 and IRSs are equipped, for instance, with a uniform linear array (ULA) with N and M antennas, respectively. The velocity vector can be defined by v=[|v| cos θᵥ, |v| sin θ_{y}]^{T}, in which θᵥ represents the direction of velocity, as illustrated in FIGS. 6a and 6b and later discussed in greater detail.

In various embodiments, the signal component 202 can, based on a first signal (e.g., a first link) (e.g., signal 316) between a receiver (e.g., a BS such as a radar receiver) (e.g., base station 304) and a target object (e.g., target 302), determine a second signal (e.g., a second link) (e.g., signal 312) between the receiver (e.g., base station 304) and the target object (e.g., target 302). In various embodiments, the first signal (e.g., signal 316) can comprise a direct signal, and the second signal (e.g., signal 312) can comprise an indirect signal conveyed via an intelligent reflecting surface (e.g., IRS 310). In this regard, an indirect signal herein can comprise a signal reflected via an IRS herein.

In one or more embodiments, the signal component 202 can select the intelligent reflecting surface (e.g., IRS 310) from a group of intelligent reflecting surfaces (e.g., IRS 310, IRS 308) that relay links between the receiver (e.g., base station 304) and the target object (e.g., target 302). For example, the signal component 202 can select the IRS that comprises the strongest signal, or according to another suitable defined selection criterion.

In various embodiments, the signal component 202 can determine the second signal (e.g., signal 312) in response to a determination (e.g., via the signal component 202) that the first signal (e.g., signal 316) is obstructed by an intermediary object (e.g., object 306) located between the receiver (e.g., base station 304) and the target object (e.g., target 302). The signal component 202 can determine whether a signal herein is obstructed using one or more of a variety of suitable processes, such as determination of signal attenuation, return time (e.g., echo delay), Doppler shift changes, multipath interference, phase shift, absence of expected echo, or another suitable obstruction determination process. Similarly, the signal component 202 can determine that the second signal (e.g., signal 312) is not obstructed by an intermediary object (e.g., object 306) located between the receiver (e.g., base station 304) and the target object (e.g., target 302). In various embodiments, such an intermediary object (e.g., object 306) can be determined to comprise a stationary object or a moving object. To determine whether an object is in motion, the signal component 202 can use one or more of a variety of suitable processes, such as determination of Doppler shift, change in range (e.g., time delay), utilization of continuous wave radar, utilization of pulse-Doppler radar, tracking history (e.g., tracking position over time), velocity magnitude calculation, or another suitable motion determination process. In this regard, object 306 is depicted as a stationary object (e.g., a building), however in other embodiments, the object 306 can be a moving object, such as a vehicle or another suitable moving object. The signal component 202 can determine the obstruction, for instance, when the first signal (e.g., a direct transmission) (e.g., signal 316) between the target object (e.g., transmitter) (e.g., target 302) and the receiver (e.g., base station 304) fail (e.g., lose connection or fall below a defined signal strength).

In various embodiments, the first signal (e.g., signal 316) or the second signal (e.g., signal 312) can comprise uplink signals. In various embodiments, the first link (e.g., signal 316) or the second link (e.g., signal 312) can comprise cellular signals transmitted via a cellular network (e.g., of the system 102 or communicatively coupled to the system 102). In this regard, such a cellular network can comprise a fifth-generation (5G) cellular network or a sixth-generation (6G) cellular network, or another suitable cellular network.

In various embodiments, the Doppler frequency component 204 can determine a Doppler frequency of the second signal (e.g., signal 312). The Doppler frequency component 204 can determine the Doppler frequency of a signal herein using one or more of a variety of Doppler frequency determination processes. For instance, the Doppler frequency component 204 can utilize the Doppler shift formula Δf=2*v*f₀/c in which Δf is the Doppler frequency shift (e.g., the difference between transmitted and received frequencies), v is the relative velocity of the target toward or away from the base station (e.g., the radial velocity), f₀ is the frequency of the transmitted base station signal (e.g., the carrier frequency), and c is the speed of light in a vacuum.

In various embodiments, the velocity estimation component 206 can, based on the Doppler frequency, determine a velocity estimation (e.g., a true velocity estimation) of the target object (e.g., target 302). In this regard, the velocity estimation component 206 can determine the estimated velocity based on the Doppler frequencies of the first signal (e.g., signal 316) and/or the second signal (e.g., signal 312). In various embodiments, the velocity estimation component 206 can determine that the target object (e.g., target 302) is in motion. To determine the velocity estimation based on the Doppler frequency, the velocity estimation component can utilize a direct process or an indirect process. Such processes are discussed immediately below and are also later discussed in additional detail with respect to FIGS. 6a and 6b.

In some embodiments, the velocity estimation of the target object (e.g., target 302) can be directly determined (e.g., by the velocity estimation component 206) (e.g., the direct process) via a linear search on an amplitude of the first signal (e.g., signal 316) or the second signal (e.g., signal 312) and/or an angle of velocity of the first signal (e.g., signal 316) or the second signal (e.g., signal 312) through a defined matching filter. In various embodiments, the linear search can be connected with the matching filter (e.g., matched filter). In various embodiments, the input of the matching filter can comprise the received signal and a given velocity. Therefore, various embodiments herein can (e.g., via the velocity estimation component 206) linearly search the velocity in a given range and calculate the output of matching filter. The velocity estimation component 206 can determine the velocity corresponding to the maximum output of matching filter as the estimated velocity by a linear search. Generally, the matching filter can comprise a signal processing filter that maximizes the detection of a specific signal in the presence of noise. By convolving (e.g., via the velocity estimation component 206) the received signal with the signal manifold corresponding to a given velocity, the output will be maximized if the given velocity equals the true velocity of the target 302.

In further embodiments, the velocity estimation (e.g., via the velocity estimation component 206) of the target object (e.g., target 302) can be indirectly determined (e.g., by the velocity estimation component 206) (e.g., the indirect process) via a matching filter on the first signal (e.g., signal 316) or the second signal (e.g., signal 312) used to estimate the Doppler frequency of the first signal (e.g., signal 316) or the second signal (e.g., signal 312), and a linear search on an amplitude of the first signal (e.g., signal 316) or the second signal (e.g., signal 312) and/or an angle of velocity of the first signal (e.g., signal 316) or the second signal (e.g., signal 312) through a defined matching filter.

In various embodiments, the indirect process herein refers to a two-step process which first estimates intermediate parameters, such as angle, Doppler frequency, distance, etc., and then estimates (e.g., via the velocity estimation component 206 and/or the geometric relationship component 208) the position of the target (e.g., target 302) based on the intermediate parameters. The direct determination process, on the other hand, refers to the process in which position is directly estimated based on the received signal without estimating the intermediate parameters. Typically, though not necessarily, the indirect process is easier and computationally efficient, while the direct process is more accurate, so either process can be utilized depending on the estimation scenario.

In various embodiments, the Doppler frequency of the second signal (e.g., signal 312) is a first Doppler frequency. In this regard, the signal component 202 can determine a third signal (e.g., signal 314) between the receiver (e.g., base station 304) and the target object (e.g., target 302), in which the third signal (e.g., signal 314) comprises an indirect signal conveyed via the IRS 308 (e.g., a second intelligent reflecting surface). The Doppler frequency component 204 can further determine a second Doppler frequency of the third signal (e.g., signal 314), in which the velocity estimation is further determined (e.g., via the velocity estimation component 206) based on the second Doppler frequency of the third signal (e.g., signal 314). In various embodiments, the velocity estimation component can utilize the above-described direct process or indirect process in the determination of the velocity estimation of the third signal (e.g., signal 314).

In various embodiments, the velocity estimation component 206 can determine a quantity of intelligent reflecting surface aided signals associated with determining the velocity estimation of the target object with a threshold accuracy. Stated otherwise, the velocity estimation component 206 can determine how many IRSs (e.g., and thus corresponding indirect signals) should be utilized to satisfy a defined velocity accuracy threshold. In this regard, such a determination by the velocity estimation component 206 can be based on the signal strength of the respective indirect signals herein. Therefore, the velocity estimation component 206 can determine the quantity of IRSs and indirect signals based on a defined relationship between signal strength and IRS indirect signal quantity.

In various embodiments, the geometric relationship component 208 can determine a geometric relationship between the target object (e.g., target 302), the intelligent reflecting surface (e.g., IRS 310), and the receiver (e.g., base station 304). The geometric relationship component 208 can determine the geometric relationship by the positions of the target object (e.g., target 302), the intelligent reflecting surface (e.g., IRS 310), and the receiver (e.g., base station 304). For instance, the positions of the IRS 310 and the base station 304 can be known to the system 102. In this regard, the positions of the IRSs 308 and 310, and the base station 304 can be predefined, as such positions are generally unchanged or at least not frequently changed. The position of the target 302 can then be determined, for instance, based a defined localization process. Such a defined localization process can comprise, for instance, triangulation using the signals herein or another suitable localization process. In this regard, the velocity estimation component 206 can further determine the velocity estimation of the target object (e.g., target 302) based on the above-described geometric relationship (e.g., to increase accuracy).

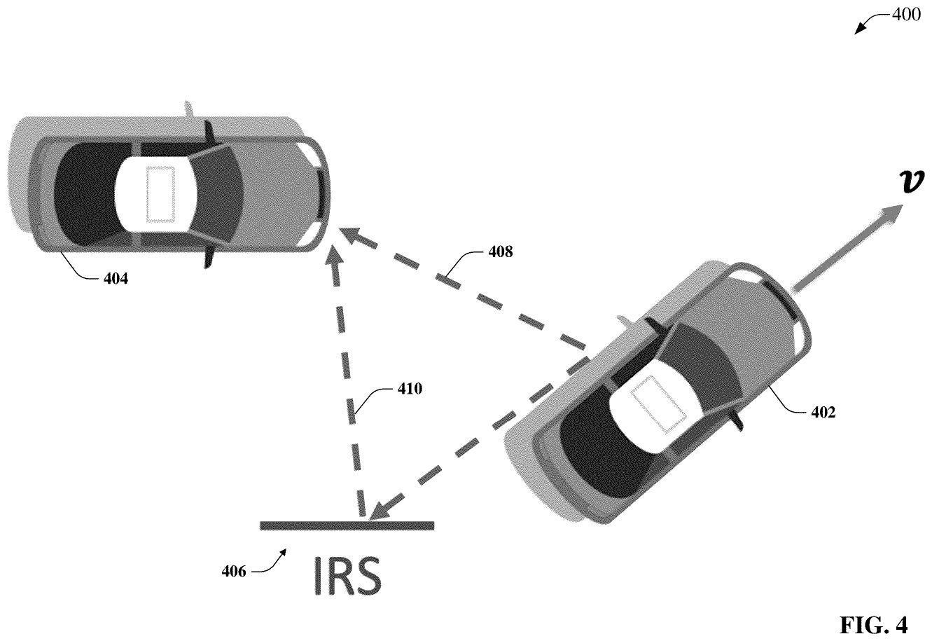

FIG. 4 is a diagram 400 of an example intelligent reflecting surface aided vehicle-to-vehicle system (e.g., comprising system 102) in accordance with one or more example embodiments described herein. FIG. 4 depicts an ISAC system in which the velocity vector of the point-like maneuvering target (e.g., vehicle 402) is estimated by another vehicle (e.g., vehicle 404) (e.g., comprising the system 102) with the aid of an IRS 406. Without the IRS 406, the estimated velocity (e.g., via the velocity estimation component 206) would be the projection of the velocity on the direct link 408. If only the direct link 408 were utilized by the system 102, according to the geometric relationship of the vehicle 402 and the vehicle 404, vehicle 402 would be perceived (e.g., from the perspective of the vehicle 404) as moving significantly away from vehicle 404. As a result, vehicle 404 would not be able to anticipate the potential collision of the vehicles depicted in FIG. 4. However, with the aid of the IRS 406 and thus the indirect link 410, the velocity of vehicle 402 can be estimated by the vehicle 404 (e.g., comprising the system 102), thus enabling the vehicle 404 to facilitate a corrective action (e.g., change direction or speed).

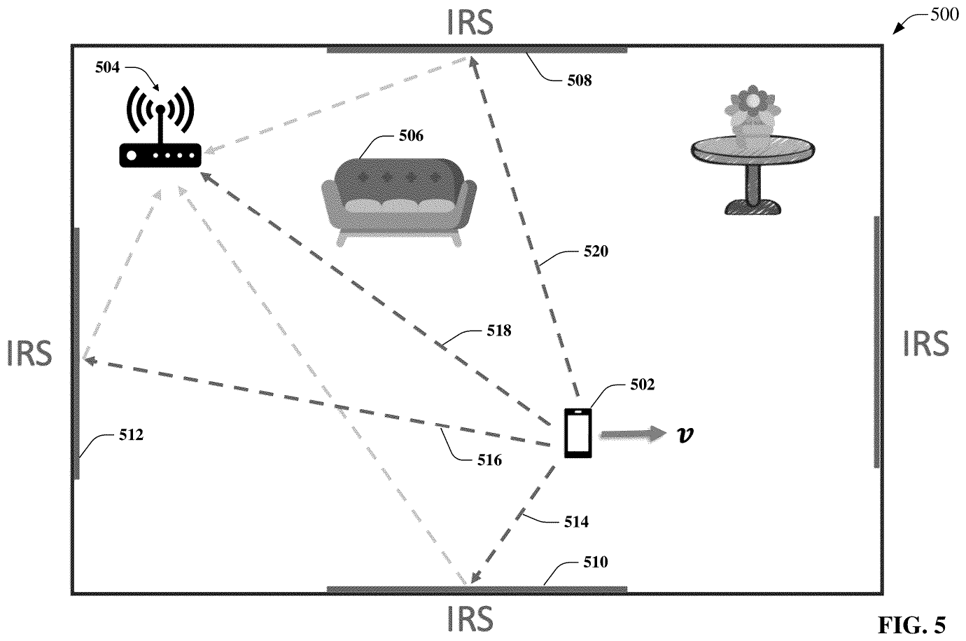

FIG. 5 is a diagram 500 of an example intelligent reflecting surface aided indoor integrated sensing and communications system (e.g., comprising the system 102) in accordance with one or more example embodiments described herein. Indoor velocity estimation (e.g., of the target 502) can be challenging, for instance, due to the complex nature of indoor environments. For instance, indoor environments often comprise a variety of potential obstructions to signals herein. Embodiments herein can comprise an ISAC system in which the velocity of the target 502 can be estimated by the base station 504 (e.g., comprising the system 102) with the aid of multiple IRSs herein. For instance, the direct signal 518 between the target 502 and the base station 504 could be obstructed, or potentially obstructed, by the object 506 (e.g., a couch). Therefore, indirect signals via IRSs herein can be utilized, such as indirect signal 514 via IRS 510, indirect signal 516 via IRS 512, and/or indirect signal 520 via IRS 508. In various embodiments, velocity estimation can be performed by the system 102, for the target 502, similarly to what is described with respect to FIGS. 3 and 4 and later discussed with respect to FIGS. 6a and 6b.

FIGS. 6a and 6b illustrate the Doppler effect over different links in accordance with one or more example embodiments described herein. A conventional mono-static radar can only access μ₀, which corresponds to the radial component of the velocity. As a result, the tangent projection would cause ambiguity (e.g., different velocities may yield the same observation at the BS). One example is illustrated in FIG. 6a where two velocity vectors, i.e., v_{amb} (608) and v (610), give the same projection. Similarly, for the IRS link, velocity ambiguity occurs as illustrated in FIG. 6b. Thus, either of the two links, without the other, would result in velocity ambiguity. Nevertheless, by jointly considering the two links, the velocity vector can be accurately determined. It is herein assumed that the distance between the base station 602 and the IRS 606 is similar to the distance between the target (e.g., target 604) and the BS 602 and/or the IRS 606.

For example, assume that the directions of the target 604 with respect to the base station 602 and the ith IRS, denoted by θ_{tb} and θᵢₜ⁽ⁱ⁾ in FIGS. 6a and 6b, are estimated (e.g., via the system 102) in advance. The received signal of the k-th pilot symbol sₖ received by the base station 602 is given by:

$${y}_{r , k} = {\underbrace{{α}_{0} {e}^{j 2 π {μ}_{0} ( k - 1 ) {T}_{s}} a ( {θ}_{tb} ) {s}_{k}}}_{direct link} + {\sum }_{i = 1}^{{N}_{R}} {\underbrace{{α}_{0} {e}^{j 2 π {μ}_{i} ( k - 1 ) {T}_{s}} G Ψ ( {θ}_{it}^{( i )} ) {s}_{k}}}_{the ith IRS link} + {p}_{r , k} , \qquad ( 1 )$$

$$where : a ( {θ}_{tb} ) {=}^{Δ} {[ 1 , {e}^{j \frac{2 π d}{λ} cos {θ}_{tb}} , … , {e}^{j \frac{2 π d ( N - 1 )}{λ}} cos {θ}_{tb} ]}^{T} , \qquad ( 2 )$$

$$b ( {θ}_{it}^{( i )} ) {=}^{Δ} {[ 1 , {e}^{j \frac{2 π d}{λ} cos {θ}_{it}^{( i )}} , … , {e}^{j \frac{2 π d ( M - 1 )}{λ}} cos {θ}_{it}^{( i )} ]}^{T} \qquad ( 3 )$$

denotes the response vector of the receiver and the IRS with d and λ representing the inner spacing of the ULA and the wavelength, respectively. G denotes the channel between base station 602 and IRS 606, which is modeled as a Rician channel comprising a light-of-sight (LoS) path and a number of non-LoS paths. Ψ denotes the phase shifter which is designed to align toward the target. α₀ and αᵢ denote the complex channel gain, accounting for the path loss and target reflectivity. The fluctuations of target reflectivity are typically modeled using the standard Swerling classes. Embodiments herein adopt the Swerling I model, in which the reflectivity is assumed to be constant within a symbol. Tₛ denotes the symbol period, and {p_{r,k}}ₖ₌₁^{N}^{ᵣ} denote the noise vectors whose elements are drawn independently from a complex Gaussian distribution with zero mean and covariance matrix

$$\frac{{σ}_{r}^{2}}{N} I .$$

μ₀ and μᵢ represent the Doppler frequencies corresponding to the direct link and the ith IRS link, respectively. Since the Doppler effect depends on the mobility of the target, embodiments herein first determine the relation between velocity v and the Doppler frequencies of direct link and IRS links.

The Doppler frequency of the relative motion between the BS and the maneuvering target 604 is given by:

$${μ}_{0} ( v , {θ}_{v} ) = \frac{v cos ( {θ}_{v} - {θ}_{t b} )}{λ} \qquad ( 4 )$$

in which v denotes the amplitude of the velocity, and θᵥ represents the angle between the velocity direction and the x-axis, (610 in FIGS. 6a and 6b). It is noted that that v cos(θᵥ−θ_{tb}) is the projection of velocity on the line across the base station 602 and target 604 (depicted as 612 in FIG. 6a). The deployment of the IRS 606 creates another path, which enables the BS to observe the velocity from an additional perspective. The Doppler frequency of the relative motion between the IRS 606 and the maneuvering target is given by:

$${μ}_{i} ( v , {θ}_{v} ) = \frac{v cos ( {θ}_{i t}^{( i )} - {θ}_{v} )}{λ} \qquad ( 5 )$$

S is denoted as the set of the indices of the existing links. In particular, 0∈S and i∈S indicate the direct link, and the ith IRS link exist, respectively. In the following, the velocity estimation process (e.g., via the system 102) for the IRS-aided systems is explained. For all i∈S, wᵢ is defined as the beamforming vector corresponding to the received beam which points to the estimated target position through the corresponding link. Given the pilot symbol sₖ=1, the output for the k-th symbol is given by

$${z}_{i , k} = {w}_{i}^{H} {y}_{r , k} = {β}_{i} {e}^{j 2 π {μ}_{i} ( k - 1 ) {T}_{s}} + {n}_{i , k} \qquad ( 6 )$$

$$where : {β}_{i} = \{ \begin{matrix}{α}_{0} {w}_{0}^{H} a ( {θ}_{tb} ) , & i = 0 \\ {α}_{i} {w}_{i}^{H} G Ψ b ( {θ}_{it}^{( i )} ) , & i = 1 , 2 , …\end{matrix} \qquad ( 7 )$$

and n_{i,k}=wᵢ^{H}p_{i,k} denotes the combined noise following the Gaussian distribution, i.e., n_{i,k}˜ [symbol] (i,σᵢ²). Stacking z_{i,k} into a vector yields:

$${z}_{i} = {[ {z}_{i , 1} , {z}_{i , 2} , … , {z}_{i , {N}_{s}} ]}^{T} ∈ {ℂ}^{{N}_{s} \times 1} \qquad ( 8 )$$

As discussed above, to estimate the velocity of a target herein, embodiments herein (e.g., via the system 102) enable two velocity estimation processes: an indirect process and a direct process.

In the indirect process, embodiments herein first estimate the Doppler frequencies of different links, based on which the velocity is obtained.

### Stage I (Estimation of μᵢ):

The steering vector in the Doppler domain is defined as:

$${a}_{f} ( μ ) {=}^{Δ} {[ 1 , {e}^{- j 2 π μ {T}_{s}} , … , {e}^{- j 2 π μ ( {N}_{s} - 1 ) {T}_{s}} ]}^{T} \qquad ( 9 )$$

The estimation of μᵢ is obtained as:

$${\hat{μ}}_{i} = arg {max}_{μ} {\vert {z}_{i}^{T} {a}_{f} ( μ ) \vert}^{2} , i ∈ 𝒮 \qquad ( 10 )$$

### Stage II (Estimation of v and θᵥ):

The amplitude and angle of the velocity can be obtained by:

$$\hat{v} , {\hat{θ}}_{v} = arg {min}_{v , {θ}_{v}} {\sum }_{i ∈ 𝒮} \vert {μ}_{i} ( v , {θ}_{v} ) - {\hat{μ}}_{i} \vert \qquad ( 11 )$$

In the direct process, embodiments herein directly determine the velocity.

The steering vector in the Doppler domain is defined as:

$${a}_{i} ( v , {θ}_{v} ) {=}^{Δ} {[ 1 , {e}^{- j 2 π {μ}_{i} ( v , {θ}_{v} ) {T}_{s}} , … , {e}^{- j 2 π {μ}_{i} ( v , {θ}_{v} ) ( {N}_{s} - 1 ) {T}_{s}} ]}^{T} \qquad ( 12 )$$

The amplitude and angle of the velocity can be obtained by:

$$\hat{v} , {\hat{θ}}_{v} = arg {max}_{v , {θ}_{v}} {\sum }_{i ∈ 𝒮} {\vert {z}_{i}^{T} {a}_{i} ( v , {θ}_{v} ) \vert}^{2} \qquad ( 13 )$$

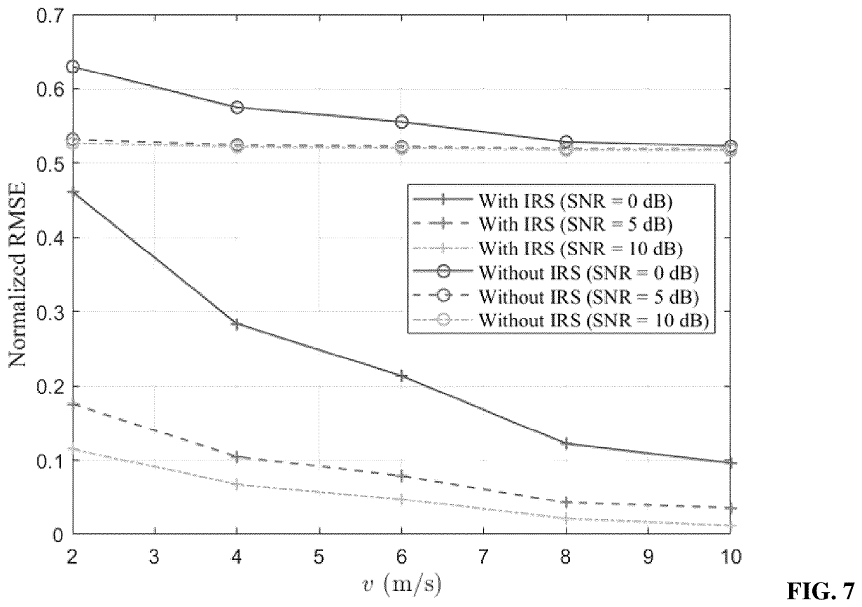

FIG. 7 shows the normalized root mean squared error as a function of target velocity with different signal-to-noise ratios in accordance with one or more example embodiments described herein. Various embodiments herein assume a direct link exists and utilize one IRS-aided link. In the experiment depicted in FIG. 7, the base station and IRS are located at positions (0, 0) and (20, 0), respectively, and all such coordinates are defined in meters. The direction of the target with respect to the base station and IRS are π/6 and 2π/3, respectively. It can be observed that the root mean square error (RMSE) performance is significantly improved with the deployment of the IRS. This is because only a radial projection of the velocity can be estimated without the IRS, such that the tangent projection of the velocity dominates the estimation error. It can also be observed that, with the IRS, the RMSE performance improves as the target velocity increases. Moreover, the gap between the curves with and without IRS becomes larger as the velocity increases, which indicates that the benefit of the deployment of IRSs will be more pronounced in a high-mobility implementation.

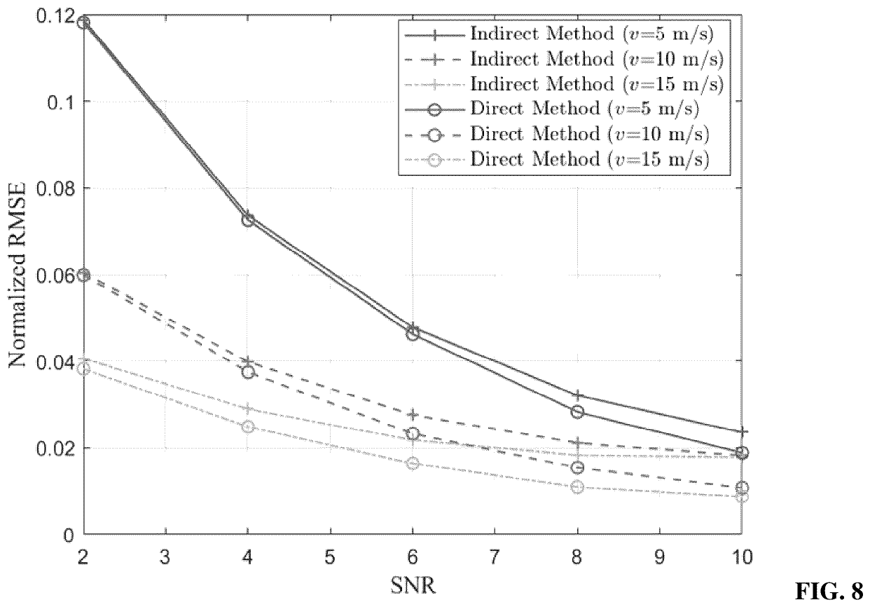

FIG. 8 shows the root mean squared error performance of direct and indirect processes in which the target moves with different velocities in accordance with one or more example embodiments described herein. In this regard, FIG. 8 shows the RMSE performance of the direct and indirect processes in which the target moves with different velocities v=5, 10, and 15 m/s. The other simulation settings are comparable to those as in FIG. 7. Repetitive description is omitted for sake of brevity. It can be observed that the velocity can be recovered with considerable accuracy. As signal to noise ratio (SNR) increases, the NMSE of both processes decreases. As compared to the indirect process, the direct process can achieve better performance, for instance, because the information loss for estimating the Doppler frequency in the first step is avoided.

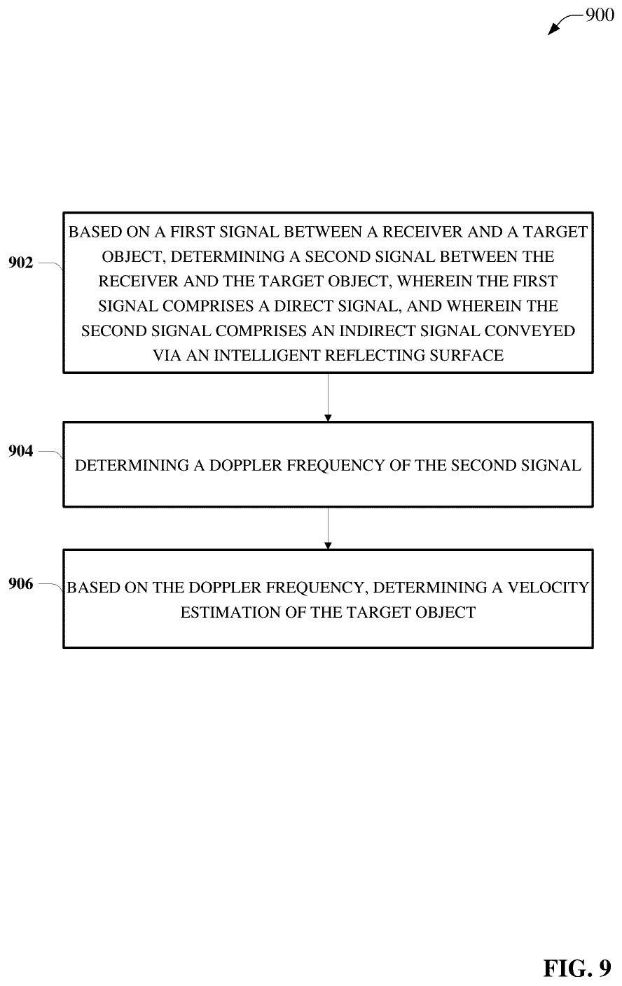

FIG. 9 is a flow diagram for a process 900 associated with velocity estimation using intelligent reflecting surfaces in accordance with one or more example embodiments described herein. At 902, the process 900 can comprise, based on a first signal (e.g., signal 316) between a receiver (e.g., base station 304) and a target object (e.g., target 302), determining (e.g., via the signal component 202) a second signal (e.g., signal 312) between the receiver (e.g., base station 304) and the target object (e.g., target 302), wherein the first signal (e.g., signal 316) comprises a direct signal, and wherein the second signal (e.g., signal 312) comprises an indirect signal conveyed via an intelligent reflecting surface (e.g., IRS 310). At 904, the process 900 can comprise determining (e.g., via the Doppler frequency component 204) a Doppler frequency of the second signal (e.g., signal 312). At 906, the process 900 can comprise, based on the Doppler frequency, determining (e.g., via the velocity estimation component 206) a velocity estimation of the target object (e.g., target 302).

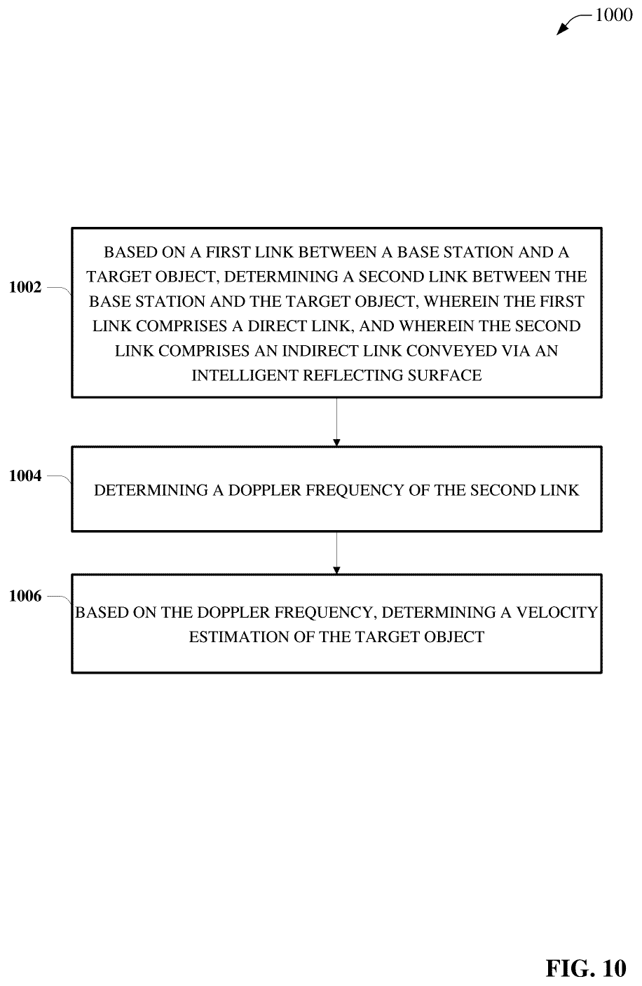

FIG. 10 is a flow diagram for a process 1000 associated with velocity estimation using intelligent reflecting surfaces in accordance with one or more example embodiments described herein. At 1002, the process 1000 can comprise, based on a first link (e.g., signal 316) between a base station (e.g., base station 304) and a target object (e.g., target 302), determining (e.g., via the signal component 202) a second link (e.g., signal 312) between the base station (e.g., base station 304) and the target object (e.g., target 302), wherein the first link (e.g., signal 316) comprises a direct link, and wherein the second link (e.g., signal 312) comprises an indirect link conveyed via an intelligent reflecting surface (e.g., IRS 310). At 1004, the process 1000 can comprise determining (e.g., via the Doppler frequency component 204) a Doppler frequency of the second link (e.g., signal 312). At 1006, the process 1000 can comprise, based on the Doppler frequency, determining (e.g., via the velocity estimation component 206) a velocity estimation of the target object (e.g., target 302).

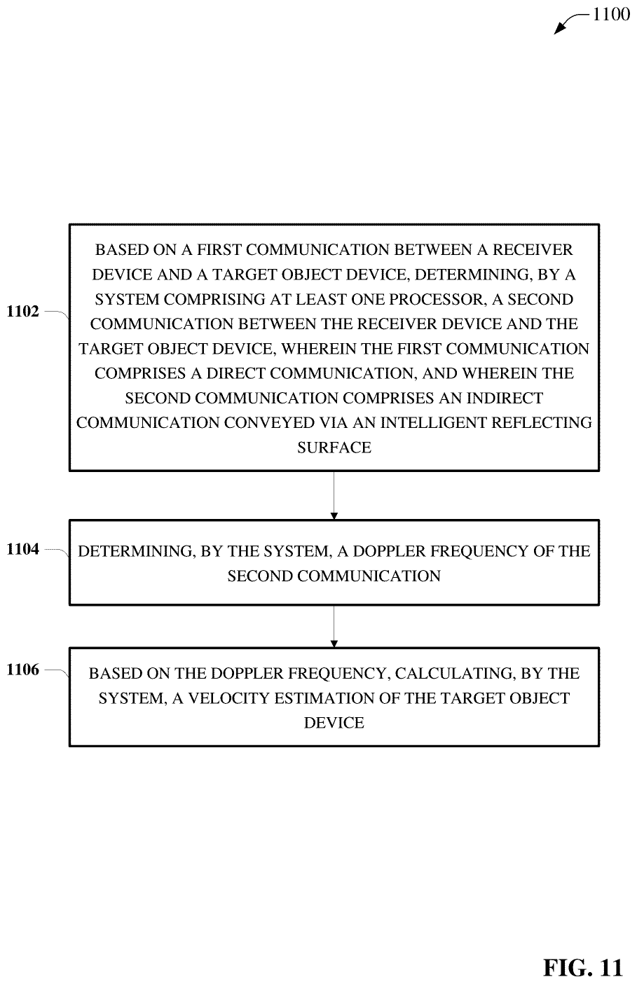

FIG. 11 is a flow diagram for a process 1100 associated with velocity estimation using intelligent reflecting surfaces in accordance with one or more embodiments described herein. At 1102, the process 1100 can comprise, based on a first communication (e.g., signal 316) between a receiver device (e.g., base station 304) and a target object device (e.g., target 302), determining (e.g., via the signal component 202), by a system comprising at least one processor, a second communication (e.g., signal 312) between the receiver device (e.g., base station 304) and the target object device (e.g., target 302), wherein the first communication (e.g., signal 316) comprises a direct communication, and wherein the second communication (e.g., signal 312) comprises an indirect communication conveyed via an intelligent reflecting surface (e.g., IRS 310). At 1104, the process 1100 can comprise determining (e.g., via the Doppler frequency component 204), by the system, a Doppler frequency of the second communication (e.g., signal 312). At 1106, the process 1100 can comprise, based on the Doppler frequency, calculating (e.g., via the velocity estimation component 206), by the system, a velocity estimation of the target object device (e.g., target 302).

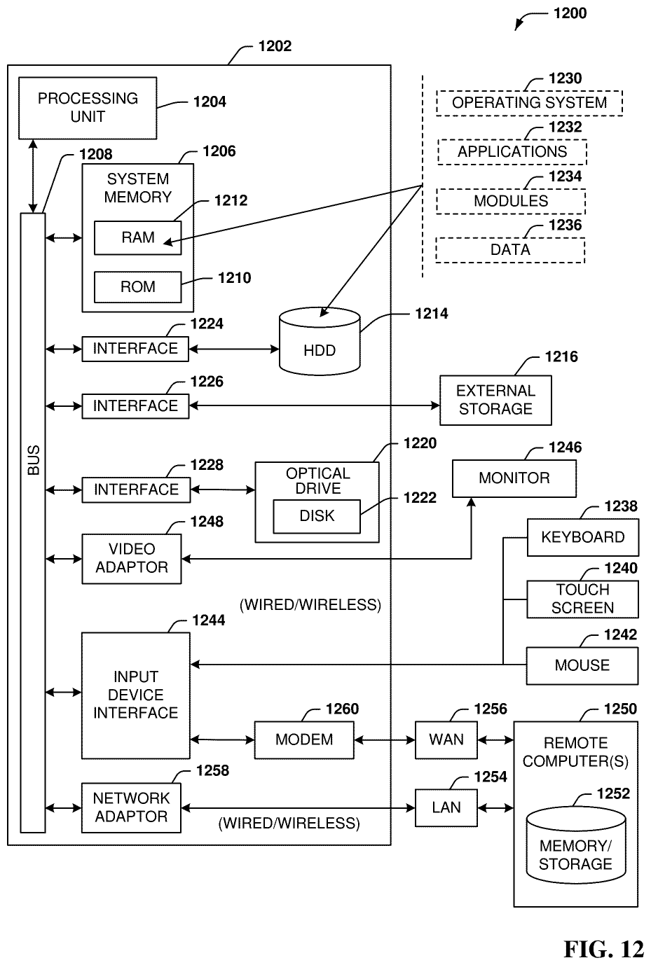

In order to provide additional context for various example embodiments described herein, FIG. 12 and the following discussion are intended to provide a brief, general description of a suitable computing environment 1200 in which the various example embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, modules, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 12, the example environment 1200 for implementing various example embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a disk 1222, such as a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can also be connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

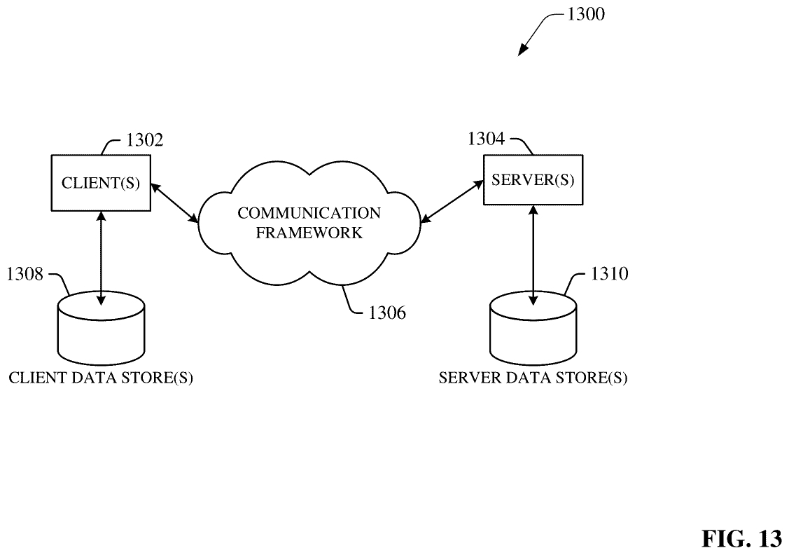

Referring now to FIG. 13, there is illustrated a schematic block diagram of a computing environment 1300 in accordance with this specification. The system 1300 includes one or more client(s) 1302, (e.g., computers, smart phones, tablets, cameras, PDA's). The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware or hardware in combination with software (e.g., threads, processes, computing devices). The servers 1304 can house threads to perform transformations of media items by employing aspects of this disclosure, for example. One possible communication between a client 1302 and a server 1304 can be in the form of a data packet adapted to be transmitted between two or more computer processes wherein data packets may include coded analyzed headspaces and/or input. The data packet can include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

In one exemplary implementation, a client 1302 can transfer an encoded file, (e.g., encoded media item), to server 1304. Server 1304 can store the file, decode the file, or transmit the file to another client 1302. It is noted that a client 1302 can also transfer uncompressed files to a server 1304 and server 1304 can compress the file and/or transform the file in accordance with this disclosure. Likewise, server 1304 can encode information and transmit the information via communication framework 1306 to one or more clients 1302.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various example embodiments. It is, of course, not possible to describe every conceivable combination of components, modules, or methods for purposes of describing the disclosed subject matter, and one skilled in the art may recognize that further combinations and permutations of the various example embodiments are possible. The disclosed subject matter is intended to embrace all such alterations, modifications, and variations that fall within the spirit and scope of the appended claims.

With regard to the various functions performed by the above-described components, modules, devices, circuits, systems, etc., the terms (including a reference to a “means”) used to describe such components or modules are intended to also include, unless otherwise indicated, any structure(s) which performs the specified function of the described component or module (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various example embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
based on a first signal between a receiver and a target object, determining a second signal between the receiver and the target object, wherein the first signal comprises a direct signal, and wherein the second signal comprises an indirect signal conveyed via an intelligent reflecting surface;
determining a Doppler frequency of the second signal; and
based on the Doppler frequency, determining a velocity estimation of the target object.

2. The system of claim 1, wherein the second signal is determined in response to a determination that the first signal is obstructed by an intermediary object located between the receiver and the target object.

3. The system of claim 1, wherein the second signal is determined not to be obstructed by an intermediary object located between the receiver and the target object.

4. The system of claim 1, wherein the velocity estimation of the target object is directly determined via a linear search on an amplitude of the first signal or the second signal and an angle of velocity of the first signal or the second signal through a defined matching filter.

5. The system of claim 1, wherein the velocity estimation of the target object is indirectly determined via:
a matching filter on the first signal or the second signal used to estimate the Doppler frequency of the first signal or the second signal; and
a linear search on an amplitude of the first signal or the second signal and an angle of velocity of the first signal or the second signal through a defined matching filter.

6. The system of claim 1, wherein the Doppler frequency of the second signal is a first Doppler frequency, wherein the intelligent reflecting surface is a first intelligent reflecting surface, and wherein the operations further comprise:
determining a third signal between the receiver and the target object, wherein the third signal comprises an indirect signal conveyed via a second intelligent reflecting surface; and
determining a second Doppler frequency of the third signal,
wherein the velocity estimation is further determined based on the second Doppler frequency of the third signal.

7. The system of claim 1, wherein the operations further comprise:
determining a quantity of intelligent reflecting surface aided signals associated with determining the velocity estimation of the target object with a threshold accuracy.

8. The system of claim 1, wherein the target object is determined to be in motion.

9. The system of claim 1, wherein the operations further comprise:
determining a geometric relationship between the target object, the intelligent reflecting surface, and the receiver, wherein the velocity estimation of the target object is further determined based on the geometric relationship.

10. A non-transitory machine-readable medium, comprising executable instructions that, when executed by at least one processor, facilitate performance of operations, comprising:
based on a first link between a base station and a target object, determining a second link between the base station and the target object, wherein the first link comprises a direct link, and wherein the second link comprises an indirect link conveyed via an intelligent reflecting surface;
determining a Doppler frequency of the second link; and
based on the Doppler frequency, determining a velocity estimation of the target object.

11. The non-transitory machine-readable medium of claim 10, wherein the first link comprises an uplink signal.

12. The non-transitory machine-readable medium of claim 10, wherein the base station comprises a radar receiver.

13. The non-transitory machine-readable medium of claim 10, wherein the intelligent reflecting surface is selected from a group of intelligent reflecting surfaces that relay links between the base station and the target object.

14. The non-transitory machine-readable medium of claim 10, wherein the first link or the second link comprise cellular signals transmitted via a cellular network.

15. The non-transitory machine-readable medium of claim 14, wherein the cellular network comprises a fifth-generation cellular network or a sixth-generation cellular network.

16. The non-transitory machine-readable medium of claim 10, wherein the first link is determined to be obstructed by a stationary object.

17. The non-transitory machine-readable medium of claim 10, wherein the first link is determined to be obstructed by a moving object.

18. A method, comprising:
based on a first communication between a receiver device and a target object device, determining, by a system comprising at least one processor, a second communication between the receiver device and the target object device, wherein the first communication comprises a direct communication, and wherein the second communication comprises an indirect communication conveyed via an intelligent reflecting surface;
determining, by the system, a Doppler frequency of the second communication; and
based on the Doppler frequency, calculating, by the system, a velocity estimation of the target object device.

19. The method of claim 18, wherein calculating the velocity estimation of the target object device comprises directly determining the velocity estimation based on a result of a linear search based on an angle of velocity of the first communication or the second communication through a defined matching filter.

20. The method of claim 18, wherein the Doppler frequency of the second communication is a first Doppler frequency, and wherein calculating the velocity estimation of the target object device comprises indirectly determining the velocity estimation:
using a matching filter on the first communication or the second communication to estimate second Doppler frequency of the first communication or the first Doppler frequency of the second communication; and
using a result of a linear search based on an amplitude of the first communication or the second communication.
